(19) United States
(12) Patent Application Publication
(10) Pub. No.: US 2011/0285821 A1
(43) Pub. Date: Nov. 24, 2011

(54) INFORMATION PROCESSING APPARATUS AND VIDEO CONTENT PLAYBACK METHOD

(75) Inventor: Takehiro Ogawa, Hamura-shi (JP)

(73) Assignee: KABUSHIKI KAISHA TOSHIBA, Tokyo (JP)

(21) Appl. No.: 13/110,818

(22) Filed: May 18, 2011

(30) Foreign Application Priority Data
May 18, 2010 (JP) 2010-114636

(51) Int. Cl. H04N 13/02

(52) U.S. Cl. 348/46; 348/E13.074

(57) ABSTRACT

According to one embodiment, an information processing apparatus executes a browser and player software plugged in the browser. The player software is configured to play back video content received from a server. A capture module captures two-dimensional video data from the player software, the two-dimensional video data being obtained by playback of the video content. A converter converts the captured two-dimensional video data to three-dimensional video data, the three-dimensional video data includes left-eye video data and right-eye video data. A three-dimensional display control module displays a three-dimensional video on a display based on the left-eye video data and right-eye video data.

### CROSS-REFERENCE TO RELATED APPLICATIONS

This application is based upon and claims the benefit of priority from Japanese Patent Application No. 2010-114636, filed May 18, 2010; the entire contents of which are incorporated herein by reference.

### FIELD

Embodiments described herein relate generally to an information processing apparatus that plays back video content items received from a server and a video content playback method applied to the above apparatus.

### BACKGROUND

Recently, various content items that are made open to the public on Web sites on the Internet are widely browsed by means of browsers of personal computers. Various video content items such as video clips or home movies can be displayed in the browser by means of a moving picture playback program as a browser plugin.

Further, recently, a system that renders a two-dimensional moving picture received from a server on three-dimensional graphics starts to be developed.

It is recently strongly required to enjoy a three-dimensional image (stereoscopic image) via the browser. However, generally, most of the content items made open to the public on the Internet are two-dimensional content items. Further, information displayed on a window of the browser contains information such as a text that is not suitable to be converted into a three-dimensional form.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an application form of an information processing apparatus according to one embodiment;

FIG. 2 is an exemplary block diagram showing the system configuration of the information processing apparatus according to the embodiment;

FIG. 3 is an exemplary block diagram showing an example of a software configuration that realizes a three-dimensional display function of the information processing apparatus according to the embodiment;

FIG. 4 is an exemplary diagram for illustrating an example of a DLL rewrite process performed by the information processing apparatus according to the embodiment;

FIG. 5 is an exemplary view showing one example of a screen image of a browser displayed on a display of the information processing apparatus according to the embodiment;

FIG. 6 is an exemplary view showing one example of a GUI displayed on the screen image shown in FIG. 5;

FIG. 7 is an exemplary view showing one example of 3-D video displayed on the display of the information processing apparatus according to the embodiment;

FIG. 8 is an exemplary diagram for illustrating a three-dimensional display operation performed by the information processing apparatus according to the embodiment; and

FIG. 9 is an exemplary flowchart for illustrating an example of the procedure of a video content data playback process performed by the information processing apparatus according to the embodiment.

### DETAILED DESCRIPTION

Various embodiments will be described hereinafter with reference to the accompanying drawings.

In general, according to one embodiment, an information processing apparatus is configured to execute a browser and player software plugged in the browser. The player software is configured to play back video content received from a server. The information processing apparatus comprises a capture module, a converter and a three-dimensional display control module. The capture module is configured to capture two-dimensional video data from the player software, the two-dimensional video data being obtained by playback of the video content. The converter is configured to convert the captured two-dimensional video data to three-dimensional video data, the three-dimensional video data comprising left-eye video data and right-eye video data. The three-dimensional display control module is configured to display a three-dimensional video on a display based on the left-eye video data and right-eye video data.

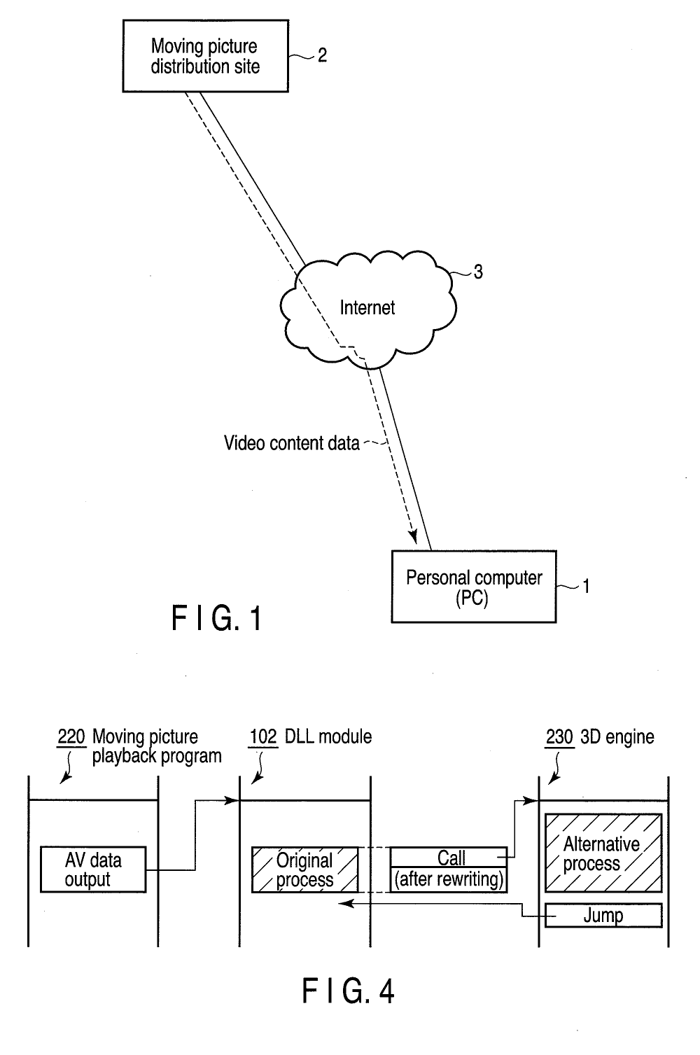

First, an application form of the information processing apparatus according to one embodiment is explained with reference to FIG. 1. The information processing apparatus is realized as a notebook personal computer (PC) 1, for example. The personal computer 1 can access Web sites on the Internet 3. The Web site examples include a moving picture distribution site 2 that may share video content data items such as home videos created by users. The moving picture distribution site 2 makes various video content data such as home movies and video clips uploaded by the users open to the public. The video content data made open to the public by the moving picture distribution site 2 is two-dimensional content. The user of the personal computer 1 can play back video content data that can be provided by the moving picture distribution site 2 while receiving the same via the Internet 3. Access to the moving picture distribution site 2 is made by software executed by the computer 1, for example, by a browser (Web browser). The video content data items on the moving picture distribution site 2 include various video content data items encoded by various encoding systems. The process of receiving and playing back video content data from the moving picture distribution site 2 is performed by means of a moving picture playback program plugged in the browser, for example. The moving picture playback program is player software as a browser plugin. The moving picture playback program is configured to play back video content data received from the server such as the moving picture distribution site 2. For example, the moving picture playback program plays back video content data while receiving the video content data by streaming, for example. Further, two-dimensional video data obtained by playing back the video content data is displayed on the display of the personal computer 1 under control of the operating system.

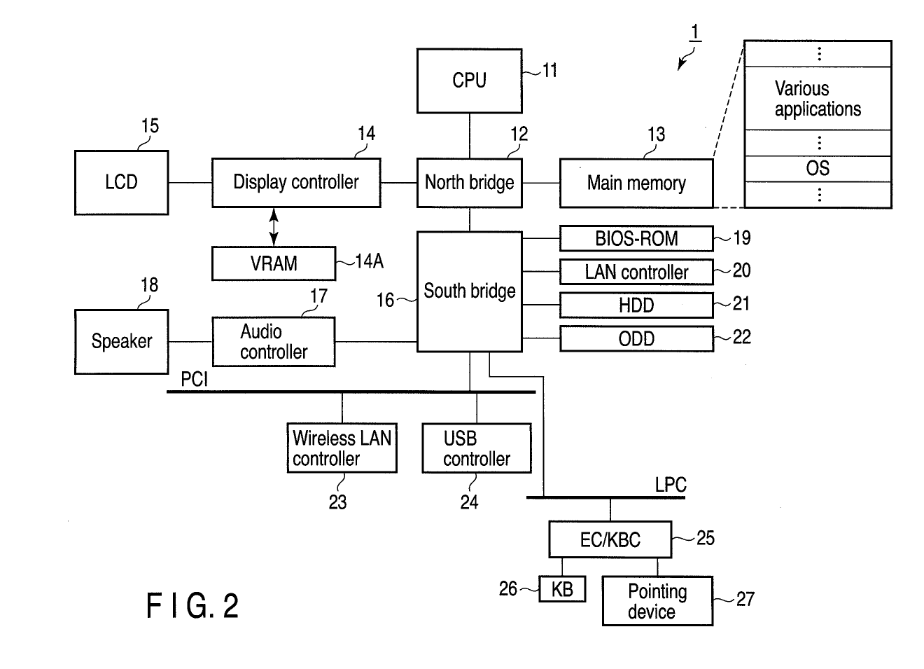

FIG. 2 is a diagram showing the system configuration of the computer 1.

As shown in FIG. 2, the computer 1 comprises a CPU 11, north bridge 12, main memory 13, display controller 14, video memory (VRAM) 14A, liquid crystal display (LCD) 15, south bridge 16, sound controller 17, speaker 18, BIOS-ROM 19, LAN controller 20, hard disk drive (HDD) 21, optical disk drive (ODD) 22, wireless LAN controller 23, USB controller 24, embedded controller/keyboard controller (EB/BC) 25, keyboard (KB) 26, pointing device 27 and the like.

The CPU 11 is a processor that controls the operation of the computer 1 and executes an operating system (OS) and various application programs which are loaded from the HOD 21 to the main memory 13. In the application programs, the browser and moving picture playback program are included. Further, in the application programs, a three-dimensional (3D) engine is included. The 3D engine is software that realizes a three-dimensional (3D) display function. The 3D engine converts a 2D image played back by means of the moving picture playback program to a 3D image on a real-time basis and displays the thus converted image on the screen of the LCD 15.

For example, a shutter system (that is also referred to as a time-sharing system) may be used for display of the 3D image on the screen of the LCD 15. For 3D image display of the shutter system, a stereo pair video comprising left-eye video data and right-eye video data is used. For example, the LCD 15 is driven at a refresh rate (for example, 120 Hz) that is twice the normal refresh rate (for example, 60 Hz). Left-eye frame data in the left-eye video data and right-eye frame data in the right-eye video data are alternately displayed on the LCD 15 at a refresh rate of 120 Hz, for example. The user can view images of the left-eye frames with the left eye and images of the right-eye frames with the right eye by means of 3D glasses (not shown) such as liquid crystal shutter glasses, for example. The 3D glasses may be configured to receive a sync signal indicating the display timings of the left-eye frame data and right-eye frame data from the computer 1 by means of infrared light or the like. The left-eye shutter and right-eye shutter of the 3D glasses are opened and closed in synchronism with the display timings of left-eye frame data and right-eye frame data on the LCD 15.

Instead, for example, a polarizing system such as an Xpol (registered trademark) system may be used for display of a 3D image. In this case, for example, interleave frame groups having left-eye images and right-eye images interleaved in the scan line unit, for example, are created and the interleave frame groups are displayed on the LCD 15. A polarizing filter that covers the screen of the LCD 15 divides, for example, left-eye images displayed on odd-numbered line groups and right-eye images displayed on even-numbered line groups displayed on the screen of the LCD 15 into different directions. The user can view the left-eye image with the left eye and right-eye image with the right eye by means of polarizing glasses.

Further, the CPU 11 also executes a basic input/output system (BIOS) stored in the BIOS-ROM 19. The BIOS is a program for hardware control.

The north bridge 12 is a bridge device that connects the local bus of the CPU 11 to the south bridge 16. A memory controller that controls access to the main memory 13 is contained in the north bridge 12. Further, the north bridge 12 also has a function of making communication with the display controller 14.

The display controller 14 is a device that controls the LCD 15 used as a display of the computer 1. For example, the LCD 15 may be realized as a touch screen device that can detect a position touched by a pen or finger. In this case, a transparent coordinate detector 15B that is called a tablet or touch panel is arranged on the LCD 15.

The south bridge 16 controls devices on a Peripheral Component Interconnect (PCI) bus and devices on Low Pin Count (LPC) bus. Further, the south bridge 16 contains an Integrated Electronics (IDE) controller that controls the HUD 21 and ODD 22, and a memory controller that access-controls the BIOS-ROM 19. In addition, the south bridge 16 has a function of making communication with the sound controller 17 and LAN controller 20.

The sound controller 17 is an audio source device and outputs audio data to be played back to the speaker 18. The LAN controller 20 is a wired communication device that makes wired communication conformant to, for example, the Ethernet (registered trademark) standard and the wireless LAN controller 23 is a wireless communication device that makes wireless communication conformant to, for example, the IEEE 802.11 standard. Further, the USE controller 24 makes communication with an external device via a cable conformant to, for example, the USE 2.0 standard.

The EC/KBC 25 is a single-chip microcomputer in which an embedded controller for power management and a keyboard controller for controlling the keyboard (KB) 26 and pointing device 27 are integrated. The EC/KEG 25 has a function of powering on/off the computer 1 in response to the operation by the user.

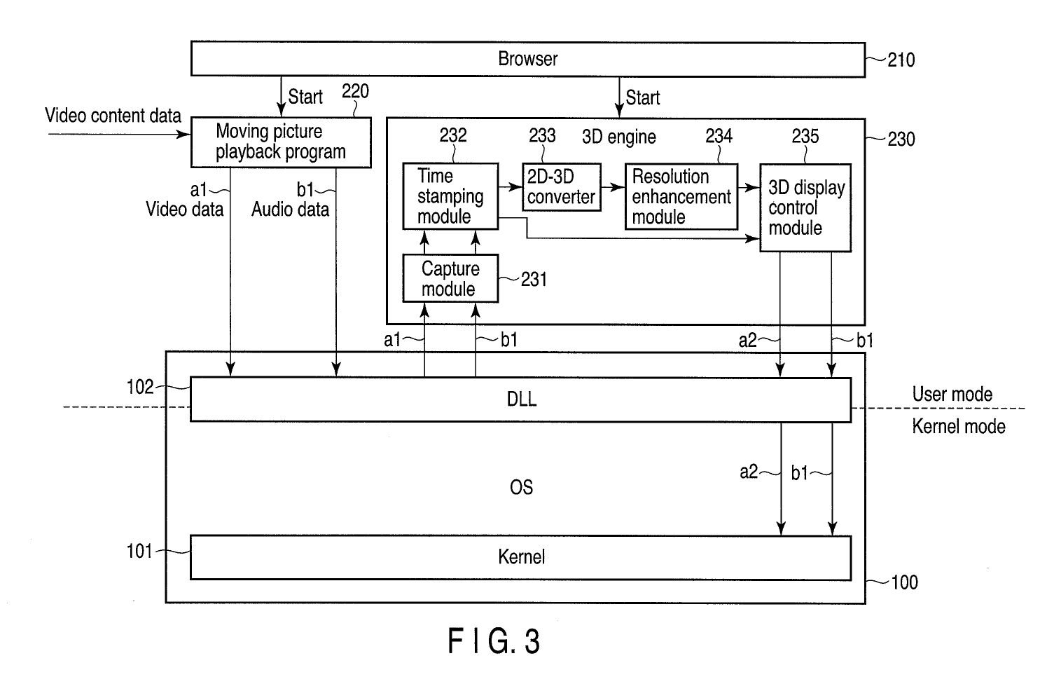

Next, the software configuration used to achieve the 3D display function is explained with reference to FIG. 3.

As shown in FIG. 3, an OS 100, browser 210, moving picture playback program 220 and 3D engine 230 are installed in the computer 1. Each of the moving picture playback program 220 and 3D engine 230 is plugged in the browser 210. That is, each of the moving picture playback program 220 and 3D engine 230 is a browser 210 plugin.

The OS 100 that performs the resource management of the computer 1 comprises a kernel 101 and DLL 102. The kernel 101 is a module that controls the respective portions (hardware) of the computer 1 shown in FIG. 2 and the DLL 102 is a module (API) that provides an interface with the kernel 101 for the application program.

The hierarchy up to a stage in which various application programs issue various requests with respect to the DLL 102 is called a user mode and the hierarchy after this stage, that is, the hierarchy after a stage in which the DLL 102 transmits the requests to the kernel 101 is called a kernel mode.

When the browser 210 browses a Web page of the moving picture distribution site 2, the browser 210 determines whether or not the Web page is a Web page including content items such as video according to tag information of the Web page. If the Web page is a Web page including content items such as video, the browser 210 starts the moving picture playback program 220 plugged in the browser 210. Then, if the user performs the operation of issuing an instruction to start playback of video content data such as video during the Web page browsing operation, the moving picture playback program 220 starts to receive the video content data from the moving picture distribution site 2.

The moving picture playback program 220 plays back video content data while receiving the video content data by streaming. The moving picture playback program 220 generates two-dimensional video data a1 that is drawing data to be displayed on the display and audio data b1 to be output from the speaker 18 by playing back the video content data. The moving picture playback program 220 outputs the video data a1 as video to be displayed on the screen of the browser to the DLL 102 of the OS 100 and outputs the audio data b1 to the DLL 102 of the OS 100.

Generally, the video data a1 and audio data b1 supplied to the DLL 102 are supplied to the kernel 101 after they are subjected to a process such as a form checking process in the DLL 102, for example. The kernel 101 performs a process of displaying video data received from the DLL 102 on the LCD 15 and a process of outputting audio data received from the DLL 102 via the speaker 18.

The 3D engine 230 is a program incorporated in the browser 210 as resident plugin software and is automatically started at the time of startup of the browser 210. The 3D engine 230 has the following functions to achieve the 3D display function described above.

1. Function of capturing 2D video data (drawing data) obtained by playback (decoding) of video content data from moving picture playback program 220.

2. Function of converting captured 2D video data to 3D video data comprising left-eye video data and right-eye video data on real-time basis by adding depths to captured 2D video data:

3. Function of displaying three-dimensional video on display based on left-eye video data and right-eye video data:

In order to realize the above functions, the 3D engine 230 comprises a capture module 231, time stamping module 232, 2D-3D converting module 233, resolution enhancement module 234 and 3D display control module 235.

The capture module 231 captures 2D video data a1 and audio data b1 which are output from the moving picture playback program 220 to the OS 100 in a playback period of video content data. Since the moving picture playback program 220 outputs the 2D video data a1 and audio data b1 to the OS 100, the capture module 231 can capture the 2D video data a1 and audio data b1, which are output from the moving picture playback program 220, via the OS 100. For example, the operation of capturing the 2D video data a1 and audio data b1 may be performed by rewriting a part of a routine in the DLL 102. In this case, the part of the routine in the DLL 102 that deals with the 2D video data a1 and audio data b1 may be rewritten into a new routine that supplies the 2D video data a1 and audio data b1 to the 3D engine 230. The new routine outputs the 2D video data a1 and audio data b1, which are output from the moving picture playback program 220, to the 3D engine 230 instead of outputting the same to the kernel 101.

Thus, the capture module 231 can capture the 2D video data a1 and audio data b1 from the moving picture playback program 220. In other words, the 2D video data a1 and audio data b1 are hooked by the capture module 231 and the 2D video data a1 and audio data b1 are not transmitted to the kernel 101 of the OS 100.

The time stamping module 232 can receive the 2D video data a1 and audio data b1 captured by the capture module 231. The time stamping module 232 adds time information (time stamp) indicating the timing at which the 2D video data a1 and audio data b1 are received to the 2D video data a1 and audio data b1. The 2D video data a1 to which the time stamp is added by means of the time stamping module 232 is transmitted to the 2D-3D converting module 233.

The 2D-3D converting module 233 is a converter that converts 2D video data to 3D video data on a real-time basis. The 2D-3D converting module 233 analyzes the 2D video data a1 and estimates depths of the 2D video data based on the result of the analysis. The 2D-3D converting module 233 detects the positional relationship between the subject and the background, the movement of an object and the like based on two-dimensional image information of each frame and image information items of frames before and after the above frame, for example. Then, the 2D-3D converting module 233 estimates depths in the pixel unit or block unit based on the detection result. In this case, the 2D-3D converting module 233 may estimate depths such that moving object is set to a position on the front-surface side. The 2D-3D converting module 233 converts 2D video data to 3D video data comprising left-eye video data and right-eye video data, based on the estimated depths. At this time, the 2D-3D converting module 233 creates a three-dimensional model of each frame based on the estimated depths, for example, and then generates a stereo pair comprising left-eye frame data and right-eye frame data based on the three-dimensional model of each frame by taking parallax into consideration. The stereo pair is generated for each frame and two frame data items of the left-eye frame data and right-eye frame data are generated for each frame.

The resolution enhancement module 234 converts the resolution of 3D video data from first resolution (original resolution) to second resolution higher than the first resolution. In the resolution enhancement process, the resolutions of frame data of left-eye video data and frame data of right-eye video data are increased up to the second resolution. In the resolution enhancement process, the image quality improving process (for example, sharpening process or the like) that enhances the image quality of 3D video data may be performed.

In general, an operation processing amount required for the 2D-3D conversion process with respect to video data with a certain resolution is larger than an operation processing amount required for the resolution enhancement process with respect to video data with the same resolution. In other words, in order to subject video data whose resolution is enhanced to 2D-3D conversion, an extremely large processing amount is required. Therefore, as described before, the order of the processes in which the 2D-3D conversion process is first performed and then the resolution enhancement process is performed makes it possible to reduce a total operation processing amount required for creating 3D video data whose resolution is enhanced in comparison with a case wherein the inverted order of the processes is used. As a result, in this embodiment, the resolution enhancement module 234 is arranged at the succeeding stage of the 2D-3D converting module 233, that is, between the 2D-3D converting module 233 and the 3D display control module 235. The resolution enhancement process may not always be performed and may be performed as required.

The 3D display control module 235 is a 3D display controller which displays a three-dimensional video on the display (LCD 15) based on left-eye video data and right-eye video data of the three-dimensional video data whose resolution is enhanced. In this case, the 3D display control module 235 creates a sequence a2 of video data for displaying a three-dimensional video based on left-eye video data and right-eye video data, and outputs the thus created sequence a2 of the video data to the display. In other words, the 3D display control module 235 outputs the sequence a2 of video data for three-dimensional video display to the OS 100 instead of the captured (hooked) video data a1.

The 3D display control module 235 can control a window that displays a three-dimensional video in cooperation with the OS 100. For example, the 3D display control module 235 may display three-dimensional video on a window different from the window of the browser 210 on the screen of the LCD 15. As a result, the three-dimensional video can be independently separated from a two-dimensional screen image in the window of the browser 210, and therefore, the three-dimensional video can be displayed with desired size on the screen of the LCD 15. The 3D display control module 235 can set a window that displays the three-dimensional video into a full-screen mode in cooperation with the OS 100.

Further, the 3D display control module 235 performs a process of synchronizing the three-dimensional video data a2 whose resolution is enhanced with the audio data b1 based on the above time stamp. Since it takes a preset time to perform the 2D-3D conversion process and resolution enhancement process, video data input to the 3D display control module 235 is delayed in comparison with audio data. By the above synchronizing process, a delay time difference caused by the 2D-3D conversion process and resolution enhancement process can be absorbed. The video data a2 and audio data b1 output to the DLL 102 from the 3D display control module 235 are supplied to the kernel 101 via the DLL 102.

FIG. 4 is a conceptual diagram for illustrating an example of a process of rewriting a part of a routine in the DLL 102.

The moving picture playback program 220 transmits video data and audio data which are obtained by decoding two-dimensional video content data to the DLL 102 of the OS 100. The 3D engine 230 rewrites the part of the routine in the DLL 102 (“original process” portion shown in the drawing) to a new routine. A call procedure (“call” shown in the drawing) for calling the 3D engine 230 is arranged in the head portion of the new routine. The process of supplying video data and audio data from the new routine to the 3D engine 230 may be performed by transmitting address information indicating an area on the main memory 13 in which video data and audio data are stored from the new routine to the 3D engine 230.

The 3D engine 230 may perform an alternative process (time stamp adding process, 2D-3D conversion process, resolution enhancement process and the like) with respect to video data and audio data on the main memory 13 and then perform a procedure (“jump” shown in the drawing) of forcedly returning a control to a point located immediately after the routine in the DLL 102. As a result, the three-dimensional video data and audio data obtained by the alternative process can be returned to the DLL 102.

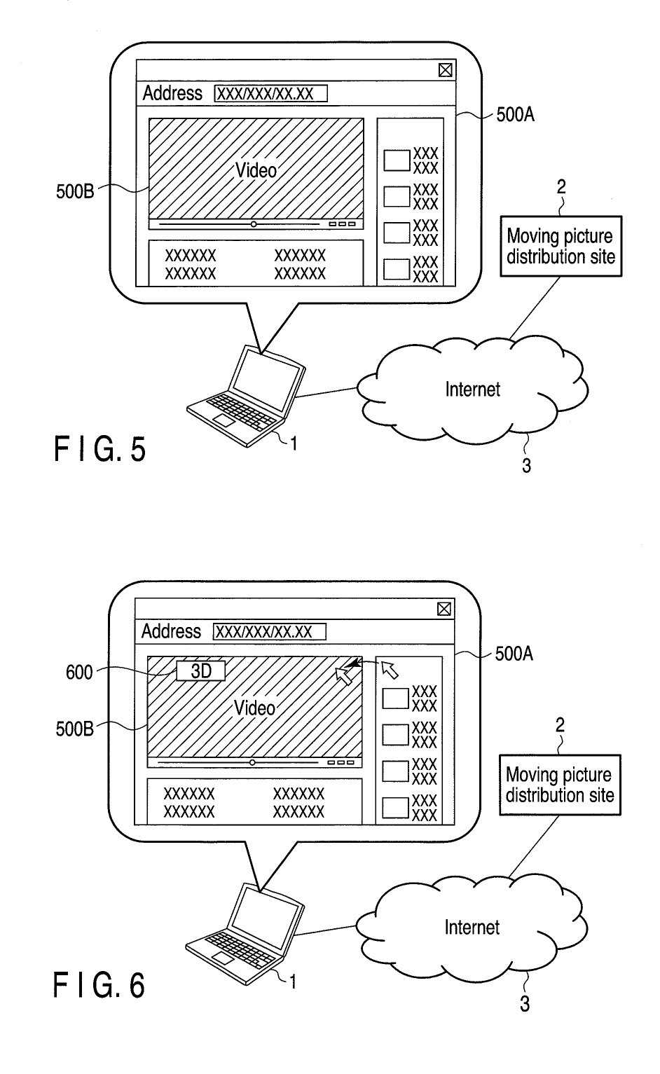

FIG. 5 shows an example of a screen image of a browser displayed on the LCD 15. A window 500A of the browser is displayed on the screen of the LCD 15. As described above, a process of decoding and playing back video content data received from the moving picture distribution site 2 is performed by means of the moving picture playback program 220 plugged in the browser. For example, encoded two-dimensional video data and encoded audio data are included in the video content data. The moving picture playback program 220 decodes the two-dimensional video data and audio data and outputs the decoded two-dimensional video data and decoded audio data. A moving picture corresponding to the decoded two-dimensional video data is displayed on a video display area 500B arranged in the window 500A of the browser. On the video display area 500B, a control object (time bar, playback button, stop button and the like) used to control playback of two-dimensional video data is also displayed.

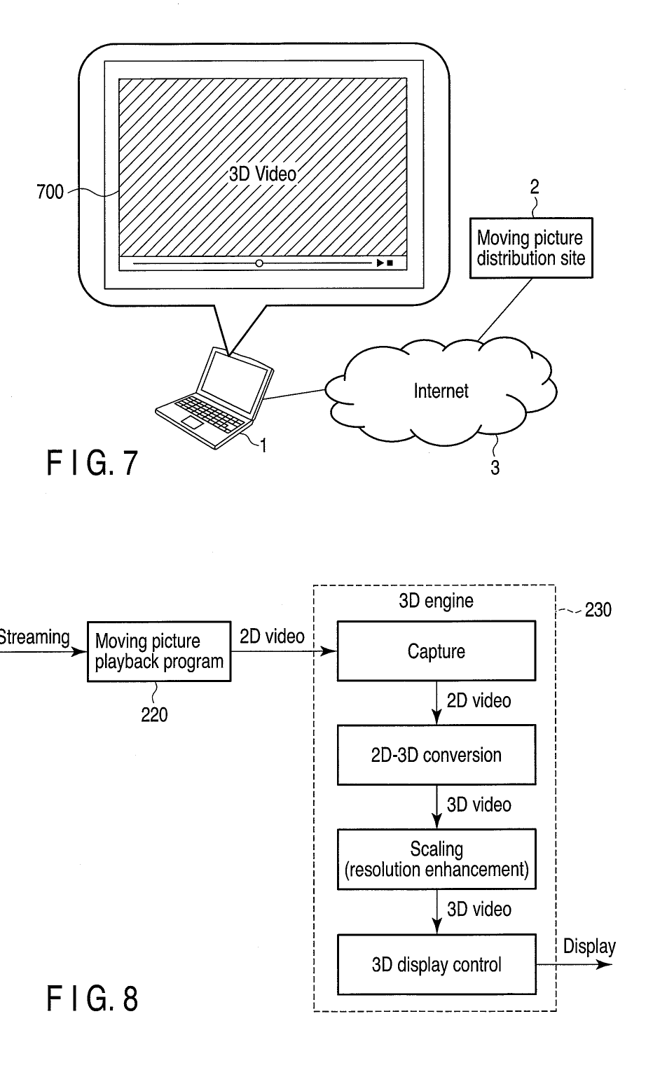

For example, when a mouse cursor is moved onto the video display area 500B during the playback of the video content data, the 3D engine 230 displays a “3D” button 600 on the video display area 500B as shown in FIG. 6. The “3D” button 600 is a GUI that permits the user to instruct execution of the 3D display process. If the “3D” button 600 is clicked by a mouse operation, the 3D engine 230 starts the 3D display process. Then, the 3D engine 230 starts to capture output data (two-dimensional video data and control object) of the moving picture playback program 220 to be displayed on the video display area 500B. Further, the 3D engine 230 converts the captured data (two-dimensional video data and control object) to three-dimensional video data and displays a moving picture corresponding to the three-dimensional (3D) video data on a window 700 on the screen of the LCD 15 different from the window 500A of the browser 210 as shown in FIG. 7. For example, the 3D engine 230 can display a moving picture corresponding to the 3D video data on the window 700 by drawing 3D video data in the drawing area on the main memory 13 assigned to the 3D engine 230 by the OS 100.

Thus, the three-dimensional video can be displayed with desired size on the screen of the LCD 15 by displaying a moving picture corresponding to the 3D video data on the window 700 different from the window 500A instead displaying the same in the window 500A of the browser 210. In this case, the window 700 may be displayed in a full-screen mode.

Thus, the 3D engine 230 captures data (two-dimensional (2D) video data and control object) displayed on the video display area 500B, instead of capturing the whole screen image of the browser, and subjects the same to 2D-3D conversion. Therefore, information on the screen image of the browser other than the video data, for example, a text can be excluded from an object to be subjected to 2D-3D conversion. As a result, only video data displayed on the screen of the browser that is different from the whole screen image of the browser can be subjected to 2D-3D conversion.

The moving picture corresponding to the 3D video data may be displayed on the video display area 5008 arranged in the window 500A of the browser.

Next, the procedure of a process performed by the 3D engine 230 is explained with reference to FIG. 8.

While capturing 2D video data (drawing data) which is output in the drawing stage of the moving picture playback program 220, the 3D engine 230 converts the 2D video data to 3D video data on the real-time basis. Then, the 3D engine 230 performs an up-scaling process (resolution enhancement process) to enhance the resolution of 3D video data. Further, for example, the 3D engine 230 creates a sequence of 3D video data corresponding to the shutter system or a sequence of 3D video data corresponding to the polarizing system based on 3D video data and outputs the sequence of 3D video data to the display (LCD 15) via the OS 100.

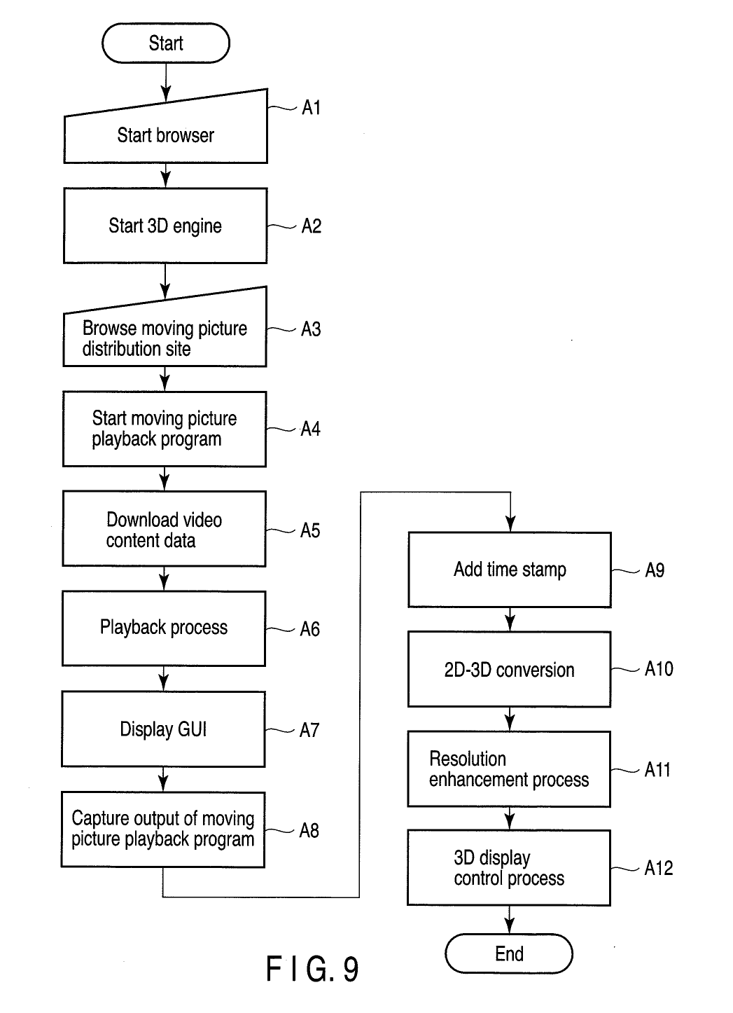

Next, the procedure of the 3D display process performed by the computer 1 of this embodiment is explained with reference to the flowchart of FIG. 9.

When the browser 210 is started by the user operation (step A1), the browser 210 first starts the 3D engine 230 (step A2). In step A2, the 3D engine 230 is loaded on the memory 13 and executed. If the user browses a Web page of the moving picture distribution site 2 by means of the browser 210 (step A3), the browser 210 starts the moving picture playback program 220 as a browser 210 plugin (step A4). Then, if the user performs the operation of issuing an instruction to start playback of video content data on the Web page, the moving picture playback program 220 starts a process of downloading the video content data (step A5). Further, while receiving video content data from the moving picture distribution site 2 by streaming, the moving picture playback program 220 plays back the video content data (step A6). In the playback process, the moving picture playback program 220 takes out encoded video data and encoded audio data from the video content data and decodes the encoded video data and encoded audio data. The decoded video data and decoded audio data are supplied to the OS 100. Then, a moving picture corresponding to the decoded video data is displayed on the video display area 500B arranged in the window 500A of the browser 210.

When the mouse cursor is moved onto the video display area 500B by the user operation, the 3D engine 230 displays the “3D” button 600 on the video display area 500B (step A7). If the “3D” button 600 is clicked by the mouse operation, the 3D engine 230 starts a process of capturing video data and audio data output from the moving picture playback program 220 to the OS 100 (step A8). Then, the 3D engine 230 respectively adds time stamps to the captured video data and audio data (step A9). Further, the 3D engine 230 analyzes the captured video data to estimate the depths of the video data and converts the video data to three-dimensional video data based on the depths (step A10). The 3D engine 230 performs a scaling process (resolution enhancement process) to enhance the resolution of the 3D video data (step A11). Then, for example, the 3D engine 230 creates a sequence of 3D video data corresponding to the shutter system from the 3D video data whose resolution is enhanced and outputs the sequence of the 3D video data to the display via the OS 100 (step A12).

As described above, according to the embodiment, two-dimensional video data output from the moving picture playback program 220 plugged in the browser 210 is captured instead of the whole screen image of the browser 210. Then, the captured two-dimensional video data is converted to three-dimensional video data and a three-dimensional video is displayed on the screen of the LCD 15 based on the three-dimensional video data. Therefore, the two-dimensional video content items in the browser 210 can be displayed as three-dimensional video content items.

Since the 3D function of this embodiment can be realized by means of a computer program, the same effect as that of this embodiment can be easily achieved simply by installing the computer program in a normal computer and executing the same by means of a computer-readable storage medium in which the computer program is stored.

Further, for example, the sequence of the 3D video data created by the 3D display control module 235 may be output to an external display such as a 3D TV via an interface such as HDMI.

In this embodiment, the explanation is made by taking a case wherein video content data received from the moving picture distribution site 2 includes both of the encoded video data and encoded audio data as an example. However, video content data received from the moving picture distribution site 2 may include only encoded video data.

The various modules of the systems described herein can be implemented as software app cations, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus configured to execute a browser and player software, wherein the player software is a browser plug-in associated with the browser, and wherein the player software is configured to play back video content received from a server, the information processing apparatus comprising:
a capture module configured to capture two-dimensional video data from the player software during playback of the video content;
a converter configured to convert the captured two-dimensional video data to three-dimensional video data, wherein the three-dimensional video data comprises left-eye video data and right-eye video data; and
a three-dimensional display control module configured to display a three-dimensional video on a display, wherein the three-dimensional video is based on the left-eye video data and the right-eye video data.

2. The information processing apparatus of claim 1, wherein the three-dimensional display control module is further configured to:
create a sequence of video data for displaying the three-dimensional video; and
output the sequence of video data to the display.

3. The information processing apparatus of claim 1, further comprising a resolution enhancement module configured to convert the three-dimensional video data from a first resolution to a second resolution that is higher than the first resolution.

4. The information processing apparatus of claim 1, wherein the browser is configured to browse a site on the Internet, and wherein the three-dimensional display control module is further configured to display the three-dimensional video in a separate window from a window of the browser.

5. The information processing apparatus of claim 1, wherein the three-dimensional display control module is further configured to set a window used to display the three-dimensional video into a full-screen mode.

6. An information processing apparatus configured to execute a browser and player software, wherein the player software is a browser plug-in associated with the browser, and wherein the player software is configured to play back video content received from a server, the information processing apparatus comprising:
a capture module configured to capture two-dimensional video data which is output from the player software to an operating system during playback of the video content;
a converter configured to convert the captured two-dimensional video data to three-dimensional video data, wherein the three-dimensional video data comprises left-eye video data and right-eye video data; and
a three-dimensional display control module configured to:
create a sequence of video data for displaying a three-dimensional video based on the left-eye video data and the right-eye video data; and
output the sequence of video data to the operating system, wherein the operating system uses the video data to display the three-dimensional video on a display.

7. A video content playback method comprising:
executing a browser and player software, wherein the player software is a browser plug-in associated with the browser, and wherein the player software is configured to play hack video content received from a server;
capturing two-dimensional video data from the player software during playback of the video content;
estimating depths of the captured two-dimensional video data and converting, based at least in part on the estimated depths, the two-dimensional video data to three-dimensional video data, wherein the three-dimensional video data comprises left-eye video data and right-eye video data; and
displaying a three-dimensional video on a display, wherein the three-dimensional video is based on the left-eye video data and right-eye video data.

8. The video content playback method of claim 7, wherein displaying the three-dimensional video on the display further comprises:
creating a sequence of video data for displaying the three-dimensional video; and
outputting the sequence of video data to the display.

9. The video content playback method of claim 7, further comprising converting the three-dimensional video data from a first resolution to a second resolution that is higher than the first resolution.
